(19) United States
(12) Patent Application Publication
(10) Pub. No.: US 2011/0032356 A1
(43) Pub. Date: Feb. 10, 2011

(54) RECORDING DEVICE FOR A MOVING VEHICLE

(76) Inventors: Wen-Ching SHIH, Hsinchu County (TW); A-Wen Yu, Taipai City (TW); Wen-Chiang Chen, Hsin-chu (TW)

Correspondence Address: RABIN & Berdo, PC, 1101 14TH STREET, NW, SUITE 500, WASHINGTON, DC, 20005, US

(21) Appl. No.: 12/536,713

(22) Filed: Aug. 6, 2009

(51) Int. Cl. H04N 7/18

(52) U.S. Cl. 348/148; 348/E07.085

(57) ABSTRACT

A recording device for a moving vehicle includes an image receiving unit, a speed calculating unit, a time unit, a positioning unit and a storing unit. The recording device records outside images when the vehicle moves via a camera lens of the image receiving unit. The speed calculating unit calculates speed using a speed gauge linked to the vehicle. Users can adjust time according to their demand by utilizing a time calculating function built in the time unit. Coordinates of vehicle location are obtained by a positioning unit linked to a satellite. The data mentioned above is stored in the storing unit. The device is installed inside the vehicle before the vehicle is factory assembled. When users start the vehicle, the recording device starts recording. When users turn off the vehicle and leave, the recording device can be re-started by using a switch. The image receiving unit keeps recording images.

### FIELD OF THE INVENTION

The present invention is to provide a recording device for a moving vehicle. It comprises an image receiving unit, a speed calculating unit, a time unit, a positioning unit and a storing unit and is fabricated in the vehicle. By using the units mentioned above, vehicle moving situations, such as environments around, speed, moving time and location are recorded and stored.

### BACKGROUND OF THE INVENTION

In the past, when people were driving a vehicle, they had accidents caused by their carelessness or other thoughtless drivers. Both sides would blame each other in order to protect their own interests. However, it is very hard to give proof which is beneficial for them. Therefore, the situation often resulted in.

Furthermore, when a traffic accident happens, each party leaves their vehicle in the site in order not to disturb status of the accident. In the result, it causes traffic jam and the site is in a state of chaos. It is possible to be punished for breaching traffic law for each party.

Moreover, for many traffic accidents, an ordinary intermediary, such as the police, member of the traffic accident evaluation committee and even the judge and the public procurator, is not the witness. Erroneous judgments often happen and cause cases of injustice. Jurisdiction resources are wasted this way. It can be seen anywhere.

Therefore, some related manufacturers have developed monitor systems. People can buy one and install it in the vehicle according to their requirement. However, recording direction of the system is unitary and not able to view the surroundings of the vehicle. Hence, it is not effective to record the status when the vehicle moves.

Some systems can show the recorded images on a rear-view mirror in the vehicle. However, this solution is easy to cause the driver distracted because he has to watch the images and unnecessary accidents. Besides, the aforementioned device is installed only for decorating by the owner. It has no credibility (it is installed by the driver) and is lack of evidence (unitary direction).

Therefore, due to the aforementioned situations, based on the related design, development and manufacturing experiences for years, the inventor worked very hard to achieve this utility model. The device is installed in a proper place inside a vehicle before the vehicle is assembled. There is a camera lens fabricated in a proper place of the body of the vehicle. By the device and the camera lens, vehicle moving situations are recorded. It is sealed and stored as a black box in the plane.

Once a traffic accident happens or the vehicle is in abnormal situation or goes by an accident, for example, someone is hurt by a pistol, blowgun or fast car, every detail can be recorded for reviewing for those who needs it. The present invention is suitable for all vehicles including minibuses, town buses, trucks and dynamic motorcycles.

### SUMMARY OF THE INVENTION

On object of the present invention is by an image receiving unit, a speed calculating unit, a time unit, a positioning unit and a storing unit to record data, such as images during a vehicle moves, speed and time and store them in the storing unit.

Another object of the present invention is that the movement recording device is installed on a proper place of the vehicle. When users turn off the vehicle and leave, the recording device can be started again by using a switch on the recording device. Therefore, the image receiving unit still keeps recording images outside of the vehicle via the camera lens.

Still another object of the present invention is to install a camera lens in a proper place of the vehicle so that the surroundings of the vehicle can be viewed. It can reduce traffic accidents, represent the whole process of an accident and protect the rights of each party.

A minor object of the present invention is that the movement recording device has been installed inside a vehicle when the vehicle manufacturer produces the vehicle.

Another minor object of the present invention is to reduce the complex procedure for the police to deal with a traffic accident and saves jurisdiction resources. Traffic jam caused by the traffic accident can be prevented as well.

### BRIEF DESCRIPTION OF THE DRAWING

FIG. 1 is a block diagram of the present invention.

FIG. 2 is a view of the present invention.

FIG. 3 is another view of the present invention.

### DETAILED DESCRIPTION OF THE PREFERRED EMBODIMENTS

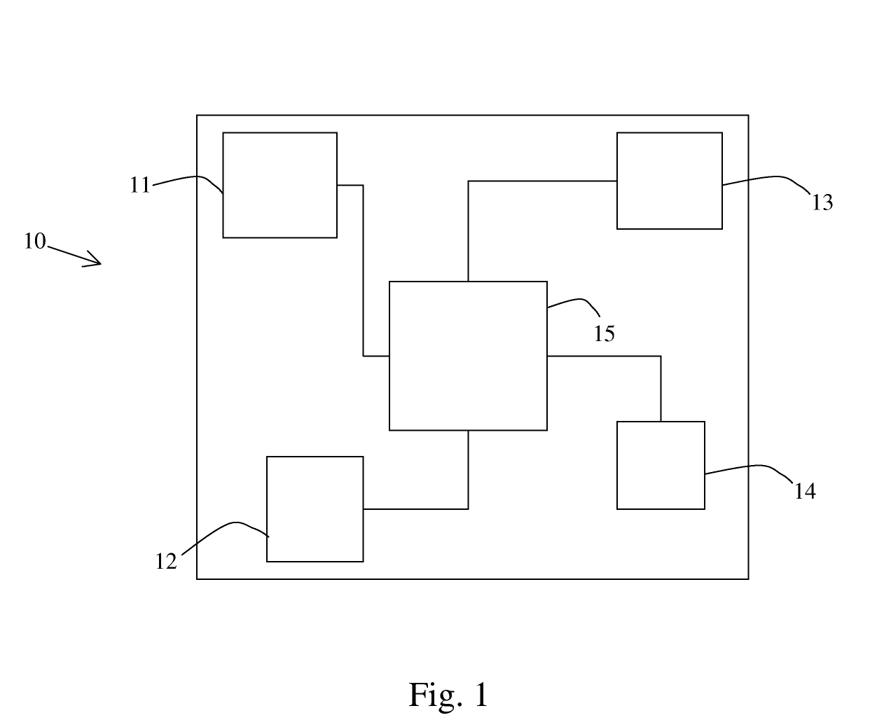

Please refer to FIG. 1. The movement recording device (10) comprises an image receiving unit (11), a speed calculating unit (12), a time unit (13), a positioning unit (14) and a storing unit (15).

The image receiving unit (11),the speed calculating unit (12), the time unit (13) and the positioning unit (14) are connected to the storing unit (15) respectively. The movement recording device (10) has been installed in a proper place and sealed when the vehicle is assembled in the factory so that it is not easy to be torn down.

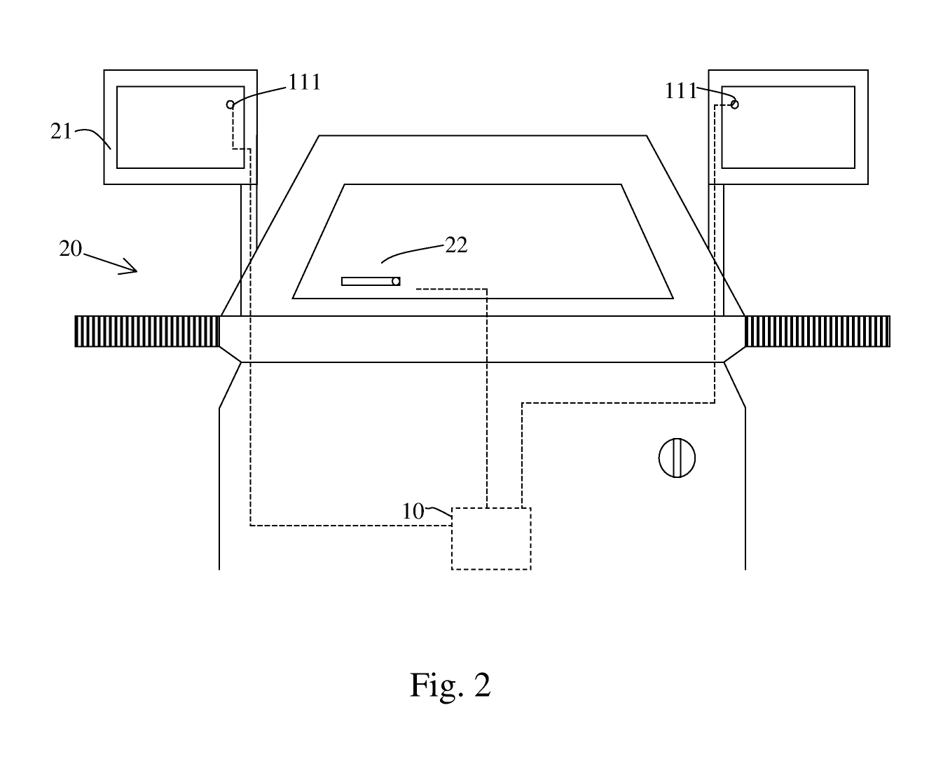

Please refer to FIG. 2. Take a motorcycle (20) for example. The movement recording device (10) can be installed in a most proper place. It can choose a place to install according to demand. A camera lens (111) is fabricated on a rear-view mirror (21) of the motorcycle (20) or according to users' requirement at a proper place, such as a front headlight or a rear taillight of the motorcycle (20). No matter it is the front, rear, left or right side of the vehicle, images can be recorded. The camera lens (111) is connected with the image receiving unit (11) of the movement recording device (10). The speed calculating unit (12) of the movement recording device (10) is connected with a speed gauge (22) of the motorcycle (20).

When the motorcycle (20) starts, the movement recording device (10) is turned on as well. The image receiving unit (11) will record images outside of the motorcycle (20) via the camera lens (111) and store the data in the storing unit (15) of the movement recording device (10). The speed calculating unit (12) will calculate speed values from the speed gauge (22) of the motorcycle (20). Similarly, the values are stored in the storing unit (15).

A time module is embedded in the time unit (13). Whether the movement recording device (10) turns on or not, the time unit (13) keeps calculating. After the movement recording device (10) is turned on, time calculated by the time unit (13) will be recorded and stored in the storing unit (15).

The positioning unit (14) has a module utilize satellite positioning. It can store the positioned coordinate data of the locations in the storing unit (15).

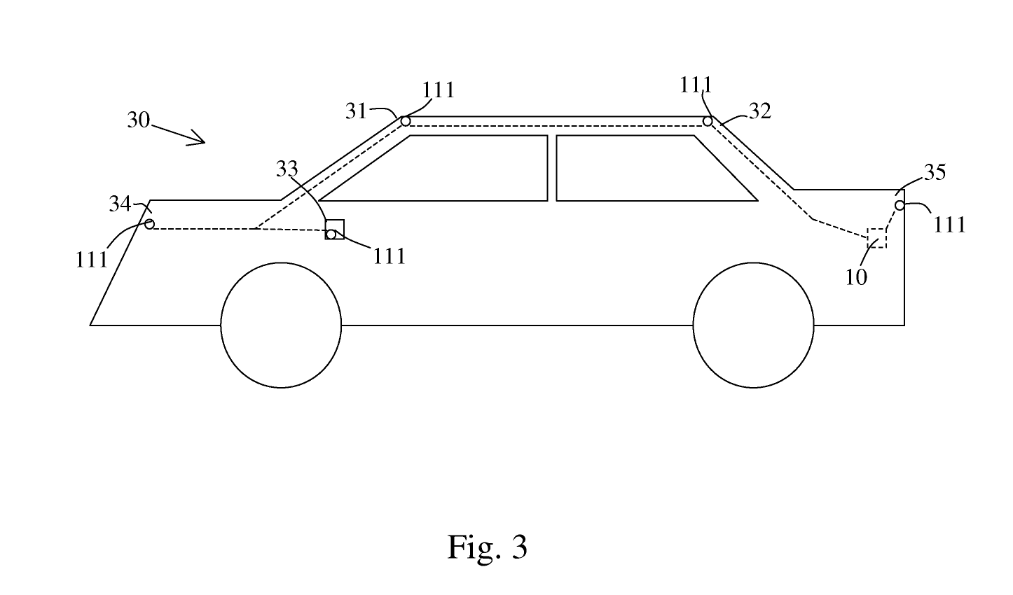

Please refer to FIG. 3. Take a car (30) for example. The movement recording device (10) can be installed on the most proper place, too. The installment can be made according to demand. A proper place of the front windshield (31), rear windshield (32), direction light (33), water tank cover (34) and tail (35) of the car (30) can be mounted with the camera lens (111). The camera lens (111) is connected to the image receiving unit (11) of the movement recording device (10). The speed calculating unit (12) of the movement recording device (10) is connected to a speed gauge of the car (30). The situation is the same as the aforementioned motorcycle.

If users encounter a traffic accident, they can hand in the movement recording device (10) to a creditable government organization to take apart. A judgment for clearing responsibility of the accident can be provided by restoring the device and analyzing the stored data of the accident. Rights of both sides can be protected. The accidental site can be recuperated so that traffic jam and waste of jurisdiction can be avoided.

Furthermore, if users would like to leave the vehicle and turn it off, the image receiving unit (11) of the movement recording device (10) can be turned on additionally so that recording of images outside of the vehicle keeps running.

What is claimed is:

1. a recording device for a moving vehicle, comprising:
an image receiving unit working with a camera lens installed in advance in the vehicle for storing images recorded by the camera lens in a storing unit; a speed calculating unit for calculating moving speed of the vehicle and commuting the speed into a value to be stored in a storing unit; a time unit, embedded with a time calculating module, for adjusting time according to demands, wherein numerical data of time are stored in a storing unit; a positioning unit for positioning a location of the vehicle by using satellite positioning principle, wherein coordinate data of the location are stored in a storing unit; a storing unit having a proper capacity of memory for storing the data from the image receiving unit, the speed calculating unit, the time unit and the positioning unit.

2. The recording device for a moving vehicle according to claim 1, wherein when users would like to leave the vehicle and turn it off, the recording device can turn on the image receiving unit of the movement recording device to keep recording outside images.
